(19) United States
(12) Patent Application Publication
(10) Pub. No.: US 2007/0129522 A1
(43) Pub. Date: Jun. 7, 2007

(54) Two-component polyurethane compound exhibiting a high early strength

(75) Inventors: Urs Burckhardt, Zurich (CH); Stefan Kislig, Widen (CH)

Correspondence Address: OLIFF & BERRIDGE, PLC, P.O. BOX 19928, ALEXANDRIA, VA, 22320, US

(73) Assignee: Sika Technology AG, Baar (CH)

(21) Appl. No.: 10/576,027

(22) PCT Filed: Oct. 15, 2004
(86) PCT No.: PCT/EP04/52555

§ 371 Date: Jan. 24, 2007

(30) Foreign Application Priority Data
Oct. 15, 2003 (EP) 03023340.7

(51) Int. Cl. C08G 18/00

(52) U.S. Cl. 528/44

(57) ABSTRACT

The invention relates to a two-component compound in which the first component A comprises at least one type of polyurethane prepolymer A1 which contains isocyanate end-groups and is produced from at least one type of polyisocyanate and the second component B which comprises water and at least one type of polyaldimine B1 and is obtainable from at least one type of polyamine PA containing aliphatic primary aminogropus and at least one type of aldehyde ALD of formula (I) or formula (II). The inventive compound is outstanding by the fact of the long processing time and high early strength thereof, a fast setting time, nevertheless without bubble formation, in particular said compound is odourless or exhibits a very low odour before, during and after thermosetting.

### TECHNICAL FIELD

The invention relates to two-component polyurethane compositions suitable as pasty adhesives, sealants, and coatings, with a long working time, high early strength, rapid and bubble-free curing, good adhesion, and slight odor generation during cure, consisting of a first component A with isocyanate groups and a second component B, which contains water and at least one polyaldimine.

### PRIOR ART

Polyurethane compositions inter alia are used for various types of bonds, seals, and coatings. They are especially suitable for bonds or seals requiring elasticity of the adhesive bond. Polyurethane compositions for elastic bonds are usually pasty materials and are used as one-component or two-component systems.

A practical adhesive must have some special properties. On the one hand, it must ensure a sufficiently long working time (potlife and open time) so the user has enough time to apply the adhesive to the desired spots and then to affix the components to be bonded and properly position them. On the other hand, the strength of the adhesive should develop rapidly, since for certain uses the adhesive bond must be able to be bear a mechanical load quite soon after application, for example because the bonded components must be transported to another location, or because any fixation must be removed. In order to make such early loading of the adhesive bond possible, the adhesive must have high early strength; i.e., the adhesive bond can be loaded to some degree even before curing is complete. This also requires that along with rapidly developing strength, the adhesive also rapidly develops good adhesion to the bonded components, since only in that case can the adhesive bond be loaded. Then the adhesive should rapidly cure to its final strength with no bubble formation, so that the elastic adhesive bond can be fully loaded as soon as possible. Furthermore, a practical adhesive should not cause any strong or unpleasant odor pollution. Especially when adhesives are used inside enclosed spaces, for example in the interior of buildings or vehicles, at most a slight odor from the materials used is tolerable, since use of the final treated object within a reasonable time is made difficult to impossible by strong odor pollution.

One-component polyurethane adhesives are generally not suitable for applications that require high early strength of the adhesive bond. Due to the fact that the curing process occurs utilizing moisture from the air, curing and therefore strength development take too long for the one-component adhesive, because the moisture from the outside required for the curing reaction must diffuse through the layers of cured material (which are becoming increasingly thicker). Furthermore, rapidly curing one-component polyurethane adhesives often tend to form bubbles during the cure, which interferes considerably with the load bearing capacity of the adhesive bond.

Considerably shorter cure times are achieved with two-component polyurethane adhesives. But the problem is to find a composition which, after the two components are mixed, first has a relatively long working time but then develops high early strength and cures rapidly. Rapid curing can be achieved by curing an isocyanate-containing component with a polyamine-containing component.

However, this reaction usually is so fast that a manageable working time is difficult to achieve. Various starting points are possible for somewhat slowing down the high reactivity of polyamines with isocyanate groups. For example, special amines can be used, for example amines with aromatic and/or sterically hindered and/or secondary amino groups. However, such special amines have disadvantages. Aromatic amines, for example, are not nontoxic, and sterically hindered amines or amines with secondary amino groups are generally expensive, sometimes lead to products with poorer mechanical properties, and are often still too reactive, especially in combination with reactive aromatic isocyanate groups.

Another option for slowing down the reaction is to add polyaldimines to polyamines in the curing agent component, as described in U.S. Pat. No. 4,108,842 or U.S. Pat. No. 4,895,883.

U.S. Pat. No. 3,932,357 describes another way to slow down the reaction, by using a dialdimine as the curing agent component.

Finally, in U.S. Pat. No. 3,420,800 polyurethanes are described which contain polyisocyanates and bisaldimines and are cured by water.

In all these patents, aldehydes producing an intense odor during application of the respective systems are mainly used.

Two-component polyurethane compositions with a long working time, high early strength, rapid and bubble-free curing, good adhesion, and slight odor generation during cure, consisting of a first component A with isocyanate groups and a second component B containing water and at least one polyaldimine, have not been known until now.

### DESCRIPTION OF THE INVENTION

The aim of the present invention is to provide a two-component polyurethane composition which has a long working time, high early strength, rapid and bubble-free curing, good adhesion, and slight odor generation during cure.

It was surprisingly found that the lafter can be achieved by means of a two-component polyurethane composition wherein the first component A contains at least one polyurethane prepolymer with isocyanate end groups which is synthesized from at least one polyisocyanate and at least one polyol, and wherein the second component B contains water and at least one polyaldimine which can be obtained from at least one polyamine with aliphatic primary amino groups and at least one aldehyde, where said aldehyde is low-odor.

Such a two-component polyurethane composition can be used, for example, to formulate pasty adhesives for elastic adhesive bonds and seals which have a long working time, high early strength, rapid and bubble-free curing, good adhesion, and slight odor generation during cure.

Such a two-component polyurethane composition has another interesting property. Using the same first component A, adhesives with different mechanical properties can be inexpensively obtained by just varying the second component B, namely by adjusting the polyamine used to synthesize the polyaldimine in the second component B as needed. This advantage is of critical importance for the adhesive manufacturer. Keeping the first component A the same for different adhesives with different mechanical properties avoids high expenses for manufacture and packaging of a large number of first components A, which (due to their high moisture sensitivity) are more expensive to handle than the second component B.

Using the described polyurethane composition, changed or new requirements can be inexpensively met regarding curing rate, tensile strength, elongation at break, and modulus of elasticity, by combining an already available first component A with a second component B that is optimized for the new requirements.

Because of the use of special polyaldimines in the second component B, which can be obtained from at least one polyamine with aliphatic primary amino groups and at least one low-odor aldehyde, polyurethane compositions are obtained with slight odor generation during and after curing. As a result, the described polyurethane compositions are also suitable for uses in enclosed spaces, such as for example in the interior of buildings or vehicles.

Because of the combination of a polyaldimine and water in the second component B, optimal reactivity with the first component A is achieved. In this way, polyurethane compositions are obtained that are distinguished by a long working time, high early strength, and rapid, bubble-free curing.

Using the present invention, it is additionally possible to formulate a modular two-component product system which consists of a universal first component A and a palette of various second components B. With such a system, polyurethane compositions can be easily obtained with working times of different lengths, different early strengths and curing rates, odor generation of varying intensity, and different mechanical properties.

### EMBODIMENT OF THE INVENTION

The present invention relates to a two-component polyurethane composition, consisting of on the one hand a first component A, containing at least one polyurethane prepolymer A1 with isocyanate end groups, synthesized from at least one polyisocyanate and at least one polyol, and on the other hand a second component B containing water and at least one polyaldimine B1 that can be obtained from at least one polyamine PA with aliphatic primary amino groups and at least one low-order aldehyde ALD as in formula (I) or formula (II).

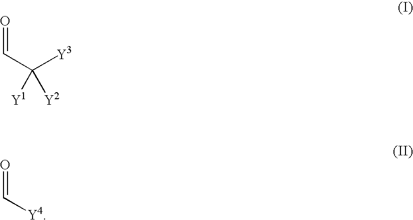

Here Y¹ and Y² either each independently represent a hydrogen atom, a hydroxyl group, or an organic residue; or they together form a carbocyclic or heterocyclic ring having a ring size between 5 and 8 atoms, preferably 6 atoms.

Y³ stands either for a substituted or unsubstituted alkyl group having at least one hetero atom;

or for a branched or unbranched alkyl or alkylene group with at least 10 C atoms;

or for a substituted or unsubstituted aryl or arylalkyl group;

or for O—R¹ or R or 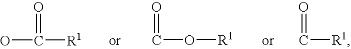
wherein R¹ in turn stands for an aryl, arylalkyl, or alkyl group with at least 3 C atoms and in each case is substituted or unsubstituted.

Y⁴ stands either for a substituted or unsubstituted aryl or heteroaryl group having a ring size between 5 and 8 atoms, preferably 6 atoms;

or for 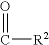
with R²=alkyl, hydroxyl, or alkoxy;

or for a substituted or unsubstituted alkenyl or arylalkenyl group with at least 6 C atoms.

In this document, by “poly” in “polyaldimine”, “polyol”, “polyisocyanate”, and “polyamine” we mean molecules that formally contain two or more of the respective functional groups.

In this document, the term “polyurethane” includes all polymers that are synthesized by the diisocyanate polyaddition process. This also includes such polymers that are nearly or completely free of urethane groups, such as polyether polyurethanes, polyester polyurethanes, polyether polyureas, polyureas, polyester polyureas, polyisocyanurates, polycarbodiimides, etc.

In this document, the term “polyamine with aliphatic primary amino groups” always means compounds formally containing two or more NH₂ groups that are bonded to an aliphatic, cycloaliphatic, or arylaliphatic residue. They are thus distinguished from aromatic amines in which the amino groups are directly bonded to an aromatic residue, such as for example in aniline or 2-aminopyridine.

By a “low-odor” substance and a substance “with slight odor generation”, we mean without distinction a substance with an odor that is only perceptible to human individuals (i.e., can be smelled) to a small degree and that therefore does not have an intense odor, such as for example formaldehyde, acetaldehyde, isobutyraldehyde, or solvents such as acetone, methyl ethyl ketone, or methyl isobutyl ketone, and where this slight odor is not perceived by most human individuals as unpleasant or repulsive.

By an “odorless” substance, we mean a substance that cannot be smelled by most human individuals and that therefore has no perceptible odor.

The two-component polyurethane composition according to the invention contains, in the first component A, at least one polyurethane prepolymer A1 with isocyanate end groups, synthesized from at least one polyisocyanate and at least one polyol.

This reaction can be carried out in such a way that the polyol and the polyisocyanate are reacted by conventional procedures, such as for example at temperatures from 50° C. to 100° C., optionally together with the use of suitable catalysts, where the polyisocyanate is measured out so that its isocyanate groups are present in stoichiometric excess relative to the hydroxyl groups of the polyol. The excess amount of polyisocyanate is selected so that in the resulting polyurethane prepolymer A1, after reaction of all the hydroxyl groups of the polyol, the free isocyanate group content is from 0.1 to 15 wt. %, preferably 0.5 to 5 wt. %, relative to the total polyurethane prepolymer A1. The polyurethane prepolymer A1 can optionally be made together with the use of plasticizers, where the plasticizers used do not contain any groups that react with isocyanates.

For example, the following commercially available polyols or any mixtures thereof can be used as the polyols to make the polyurethane prepolymer A1:
Polyoxyalkylene polyols, also called polyether polyols, which are polymerization products of ethylene oxide, 1,2-propylene oxide, 1,2- or 2,3-butylene oxide, tetrahydrofuran or mixtures thereof, optionally polymerized using an initiator molecule with two or more active hydrogen atoms such as, for example, water, ammonia, or compounds with several OH or NH groups such as, for example, 1,2-ethanediol, 1,2- and 1,3-propanediol, neopentyl glycol, diethylene glycol, triethylene glycol, the isomeric dipropylene glycols and tripropylene glycols, the isomeric butanediols, pentanediols, hexanediols, heptanediols, octanediols, nonanediols, decanediols, and undecanediols, 1,3- and 1,4-cyclohexanedimethanol, bisphenol A, hydrogenated bisphenol A, 1,1,1-trimethylolethane, 1,1,1-trimethylolpropane, glycerol, aniline, as well as mixtures of the aforementioned compounds. Polyoxyalkylene polyols can be used that have a low degree of unsaturation (measured according to ASTM D-2849-69 and expressed in milliequivalents of unsaturation per gram polyol (meq/g)), synthesized for example using “double metal cyanide complex catalysts” (DMC catalysts), as well as polyoxyalkylene polyols with a higher degree of unsaturation, synthesized for example using anionic catalysts such as NaOH, KOH, or alkali metal alkoxides.

Polyoxyalkylene diols or polyoxyalkylene triols, in particular polyoxypropylene diols or polyoxypropylene triols, are especially suitable.

Polyoxyalkylene diols or polyoxyalkylene triols are especially suitable which have a degree of unsaturation below 0.02 meq/g and a molecular weight in the range from 1000 to 30 000 g/mol, as well as polyoxypropylene diols and triols with a molecular weight from 400 to 8000 g/mol. In this document, by “molecular weight” we mean the average molecular weight Mₙ.

“EO-endcapped” (ethylene oxide-endcapped) polyoxypropylene diols or triols are also especially suitable. The latter are special polyoxypropylene polyoxyethylene polyols that, for example, can be obtained by alkoxylating pure polyoxypropylene polyols with ethylene oxide, after completion of polypropoxylation, and thus have primary hydroxyl groups.
Polybutadiene with hydroxy functional groups.
Polyester polyols, synthesized for example from dihydric or trihydric alcohols such as, for example, 1,2-ethanediol, diethylene glycol, 1,2-propanediol, dipropylene glycol, 1,4-butanediol, 1,5-pentanediol, 1,6-hexanediol, neopentyl glycol, glycerol, 1,1,1-trimethylolpropane or mixtures of the aforementioned alcohols, with organic dicarboxylic acids or their anhydrides or esters such as, for example, succinic acid, glutaric acid, adipic acid, suberic acid, sebacic acid, dodecanedicarboxylic acid, maleic acid, fumaric acid, phthalic acid, isophthalic acid, terephthalic acid, and hexahydrophthalic acid or mixtures of the aforementioned acids, as well as polyester polyols derived from lactones such as, for example, ε-caprolactone.
Polycarbonate polyols, as can be obtained, for example, by reaction of the above-indicated alcohols (used to synthesize the polyester polyols) with dialkyl carbonates, diaryl carbonates, or phosgene.
Polyacrylate and polymethacrylate polyols.

The indicated polyols have an average molecular weight from 250 to 30 000 g/mol and an average number of OH functional groups in the range from 1.6 to 3.

In addition to the indicated polyols, the following can be used to make the polyurethane prepolymer A1: low molecular weight dihydric or polyhydric alcohols such as, for example, 1,2-ethanediol, 1,2- and 1,3-propanediol, neopentyl glycol, diethylene glycol, triethylene glycol, the isomeric dipropylene glycols and tripropylene glycols, the isomeric butanediols, pentanediols, hexanediols, heptanediols, octanediols, nonanediols, decanediols, and undecanediols, 1,3- and 1,4-cyclohexanedimethanol, hydrogenated bisphenol A, dimers of fatty alcohols, 1,1,1-trimethylolethane, 1,1,1-trimethylolpropane, glycerol, pentaerythritol, sugar alcohols and other alcohols with a high number of OH groups, low molecular weight alkoxylation products of the aforementioned dihydric and polyhydric alcohols as well as mixtures of the aforementioned alcohols.

Commercially available polyisocyanates are used to make the polyurethane prepolymer A1. The following polyisocyanates that are very well known in polyurethane chemistry can be mentioned as examples:

2,4- and 2,6-toluylene diisocyanate (TDI) and any mixtures of their isomers, 4,4′-diphenylmethane diisocyanate (MDI), the positional isomers of diphenylmethane diisocyanate, 1,3- and 1,4-phenylene diisocyanate, 2,3,5,6-tetramethyl-1,4-diisocyanatobenzene, 1,6-hexamethylene diisocyanate (HDI), 2-methylpentamethylene-1,5-diisocyanate, 2,2,4- and 2,4,4-trimethyl-1,6-hexamethylene diisocyanate (TMDI), 1,12-dodecamethylene diisocyanate, cyclohexane-1,3and -1,4-diisocyanate and any mixtures of these isomers, 1-isocyanato-3,3,5-trimethyl-5-isocyanatomethyl-cyclohexane (=isophorone diisocyanate or IPDI), perhydro-2,4′- and -4,4′-diphenylmethane diisocyanate (HMDI), 1,4-diisocyanato-2,2,6-trimethylcyclohexane (TMCDI), m- and p-xylylene diisocyanate (XDI), 1,3- and 1,4-tetramethylxylylene diisocyanate (TMXDI), 1,3-and 1,4-bis(isocyanatomethyl)cyclohexane, as well as oligomers and polymers of the aforementioned isocyanates, as well as any mixtures of the aforementioned isocyanates. MDI, TDI, HDI, and IPDI are especially preferred.

The first component A also has the ability to cure by itself, and therefore when not in contact with the second component B. The isocyanate groups of the first component A can react with moisture, for example from the air, and thus cure the polymer, analogously to a one-component moisture-curing polyurethane composition. If desired, the reaction of the isocyanate groups with water can be additionally accelerated by adding a suitable catalyst to the first component A. Suitable catalysts include, for example, organotin compounds such as dibutyltin dilaurate, dibutyltin dichloride, dibutyltin diacetylacetonate, organobismuth compounds or bismuth complexes, or amino group-containing compounds such as, for example, 2,2′-dimorpholinodiethyl ether.

The two-component polyurethane composition according to the invention contains water and at least one polyaldimine B1 in the second component B.

The polyaldimine B1 can be synthesized from at least one polyamine PA with aliphatic primary amino groups and at least one aldehyde ALD by means of a condensation reaction with elimination of water. Such condensation reactions are very well known and are described, for example, in Houben-Weyl, Methoden der organischen Chemie [Methods of Organic Chemistry], Vol. XI/2, pages 73 ff. These are equilibrium reactions, where the equilibrium is mainly shifted toward the polyaldimine. That is, when a polyamine with aliphatic primary amino groups is mixed with at least a stoichiometric amount of an aldehyde, the corresponding polyaldimine is spontaneously formed, regardless of whether or not the water eliminated in the reaction is removed from the reaction mixture.

Polyamines that are well known in polyurethane chemistry (as are used inter alia for two-component polyurethanes) are used as the polyamines PA with aliphatic primary amino groups to synthesize the polyaldimine B1. As examples, we may mention the following: ethylenediamine, 1,2- and 1,3-propanediamine, 2-methyl-1,2-propanediamine, 2,2-dimethyl-1,3-propanediamine, 1,3- and 1,4-butanediamine, 1,3-and 1,5-pentanediamine, 1,6-hexamethylenediamine, 2,2,4- and 2,4,4-trimethylhexamethylenediamine and mixtures thereof, 1,7-heptanediamine, 1,8-octanediamine, 4-aminomethyl-1,8-octanediamine, 1,9-nonanediamine, 1,10-decanediamine, 1,11-undecanediamine, 1,12-dodecanediamine, methyl-bis(3-aminopropyl)amine, 1,5-diamino-2-methylpentane (MPMD), 1,3-diaminopentane (DAMP), 2,5-Dimethyl-1,6-hexamethylenediamine, cycloaliphatic polyamines such as 1,2,-1,3- and 1,4-diaminocyclohexane, bis(4-aminocyclohexyl)methane, bis(4-amino-3-methylcyclohexyl)methane, bis(4-amino-3-ethylcyclohexyl)methane, bis(4-amino-3,5-dimethylcyclohexyl)methane, 1-amino-3-aminomethyl-3,5,5-trimethylcyclohexane (=isophoronediamine, or IPDA), 2- and 4-methyl-1,3-diaminocyclohexane and mixtures thereof, 1,3- and 1,4-bis(aminomethyl)cyclohexane, 1-cyclohexylamino-3-aminopropane, 2,5(2,6)-bis(aminomethyl)bicyclo[2.2.1]heptane (NBDA, manufactured by Mitsui Chemicals), 3(4),8(9)-bis(aminomethyl)tricyclo[5.2.1.0^{2,6}]decane, 1,4-diamino-2,2,6-trimethylcyclohexane (TMCDA), 3,9-bis(3-aminopropyl)-2,4,8,10-tetraoxaspiro[5.5]undecane, 1,3- and 1,4-xylylenediamine, ether group-containing aliphatic polyamines such as bis(2-aminoethyl) ether, 4,7-dioxadecane-1,10-diamine, 4,9-dioxadodecane-1,12-diamine and higher oligomers thereof, polyoxyalkylene polyamines with theoretically two or three amino groups, which can be obtained for example under the name Jeffamine® (manufactured by Huntsman Chemicals), as well as mixtures of the aforementioned polyamines.

Preferred polyamines PA are 1,6-hexamethylenediamine, MPMD, DAMP, 2,2,4- and 2,4,4-trimethylhexamethylenediamine, 4-aminomethyl-1,8-octanediamine, IPDA, 1,3- and 1,4-xylylenediamine, 1,3- and 1,4-bis(aminomethyl)cyclohexane, bis(4-aminocyclohexyl)methane, bis(4-amino-3-methylcyclohexyl)methane, 3(4),8(9) -bis(aminomethyl)tricyclo[5.2.1.0^{2,6}]decane, 1,2-, 1,3- and 1,4-diaminocyclohexane, 1,4-diamino-2,2,6-trimethylcyclohexane, polyoxyalkylene polyamines with theoretically two or three amino groups, in particular Jeffamine® EDR-148, Jeffamine® D-230, Jeffamine® D400 and Jeffamine® T-403, as well as in particular mixtures of two or more of the aforementioned polyamines.

The polyaldimine B1 contained in the composition according to the invention can be obtained from at least one polyamine PA with aliphatic primary amino groups and from at least one aldehyde ALD, where this aldehyde is low-odor. An essential feature of the invention is that the aldehyde used is low-odor.

In a first embodiment, aldehydes ALD of the following formula (I) are used:

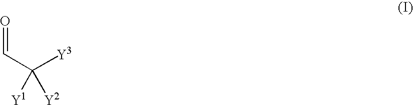

Y¹ and Y² each independently represent on the one hand a hydrogen atom, a hydroxyl group, or an organic residue.

On the other hand, Y¹ and Y² can join together to form a carbocyclic or heterocyclic ring, having a ring size between 5 and 8 atoms, preferably 6 atoms.

There are four options for Y³:

Y³ can stand for a substituted or unsubstituted alkyl group having at least one hetero atom, in particular in the form of an ether oxygen, a carboxyl, ester, or hydroxyl group.

Y³ can also stand for a branched or unbranched alkyl or alkylene group with at least 10 C atoms.

In addition, Y³ can also stand for a substituted or unsubstituted aryl or arylalkyl group.

Finally, Y³ can also stand for a residue of formula O—R¹ or 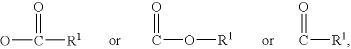
wherein R¹ in turn stands for an aryl, arylalkyl, or alkyl group with at least 3 C atoms and in each case is substituted or unsubstituted.

Examples of compounds as in formula (I) are

decanal, dodecanal; ethers derived from 2-hydroxy-2-methylpropanal and alcohols such as propanol, isopropanol, butanol and 2-ethylhexanol; esters derived from 2-formyl-2-methylpropionic acid and alcohols such as propanol, isopropanol, butanol and 2-ethylhexanol; esters derived from 2-hydroxy-2-methylpropanal and carboxylic acids such as butyric acid, isobutyric acid, and 2-ethylhexanoic acid; aldoses such as, for example, glyceraldehyde, erythrose, or glucose; 2-phenylacetaldehyde, 2-phenylpropionaldehyde (hydratropaldehyde); as well as the aldehydes listed below as especially suitable.

On the one hand, compounds of formula (III) are especially suitable:

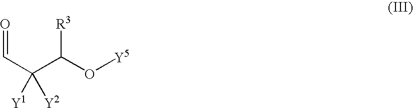

where R³ and Y⁵ each independently stand for a hydrogen atom or for an alkyl or arylalkyl group, and Y¹ and Y² have the meaning described above.

As examples of compounds of formula (III), we should mention 3-hydroxypivalaldehyde, 3-hydroxy-2-methylpropionaldehyde, 3-hydroxypropionaldehyde, 3-hydroxybutyraldehyde, 3-hydroxyvaleraldehyde; β-hydroxyaldehyde, as formed by a cross-aldol reaction from formaldehyde and aldehydes such as 2-methylbutyraldehyde, 2-ethylbutyraldehyde, 2-methylvaleraldehyde, 2-ethylcapronaldehyde, cyclopentanecarboxaldehyde, cyclohexanecarboxaldehyde, 1,2,3,6-tetrahydrobenzaldehyde, 2-methyl-3-phenylpropionaldehyde, 2-phenylpropionaldehyde (hydratropaldehyde), diphenylacetaldehyde; as well as ethers derived from such β-hydroxyaldehydes and alcohols such as methanol, ethanol, propanol, isopropanol, butanol, 2-ethylhexanol or fatty alcohols such as, for example, 3-methoxy- and 3-ethoxy- and 3-propoxy- and 3-isopropoxy- and 3-butoxy-, as well as 3-(2-ethylhexoxy)-2,2-dimethylpropanal.
On the other hand, compounds of formula (IV) are especially suitable:

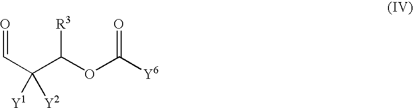

where Y¹, Y² and R³ have the meaning described above, and

Y⁶ represents a hydrogen atom or an alkyl or arylalkyl or aryl group, optionally with at least one hetero atom, in particular with at least one ether oxygen, and optionally with at least one carboxyl group, and optionally with at least one ester group, or a monounsaturated or polyunsaturated linear or branched hydrocarbon chain.

Examples of preferred aldehydes of formula (IV) are esterification products derived from the already mentioned β-hydroxyaldehydes such as 3-hydroxypivalaldehyde, 3-hydroxyisobutyraldehyde, 3-hydroxypropionaldehyde, 3-hydroxybutyraldehyde, 3-hydroxyvaleraldehyde, 2-hydroxymethyl-2-methylbutyraldehyde, 2-hydroxymethyl-2-ethylbutyraldehyde, 2-hydroxymethyl-2-methylvaleraldehyde, 2-hydroxymethyl-2-ethylhexanal, 1-hydroxymethyl cyclopentanecarbaldehyde, 1-hydroxymethyl cyclohexanecarbaldehyde, 1-hydroxymethyl cyclohex-3-enecarbaldehyde, 2-hydroxymethyl-2-methyl-3-phenylpropionaldehyde, 3-hydroxy-2-methyl-2-phenyl-propionaldehyde and 3-hydroxy-2,2-diphenylpropionaldehyde reacted with carboxylic acids such as formic acid, acetic acid, propionic acid, butyric acid, isobutyric acid, 2-ethylcapronoic acid, and benzoic acid, as well as the aldehydes listed below as especially preferred.

In an especially preferred embodiment, aldehydes ALD of formula (IV) are used which are odorless and for which the residues R³ and Y⁶ are limited as follows:

R³ stands for a hydrogen atom, and

Y⁶ stands on the one hand for a linear or branched alkyl chain with 11 to 30 carbon atoms, optionally with at least one hetero atom, in particular with at least one ether oxygen,

or for a monounsaturated or polyunsaturated linear or branched hydrocarbon chain with 11 to 30 carbon atoms,

or for a residue of formula (V) or (VI).

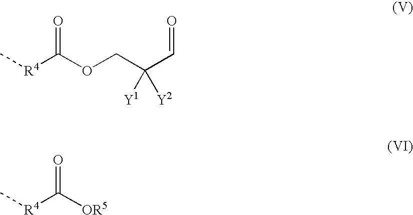

In formulas (V) and (VI), R⁴ stands for a linear or branched or cyclic alkylene chain with 2 to 16 carbon atoms, optionally with at least one hetero atom, in particular with at least one ether oxygen, or for a monounsaturated or polyunsaturated linear or branched or cyclic hydrocarbon chain with 2 to 16 carbon atoms,

and R⁵ stands for a linear or branched alkyl chain with 1 to 8 carbon atoms, and

Y¹ and Y² have the meaning described above.

The dashed line in formulas (V) and (VI) in each case indicates the linkage position.

This embodiment of the invention makes it possible to make polyurethane compositions not only with slight odor generation but also without any perceptible odor. This is especially advantageous for uses in the interior of buildings and vehicles.

Examples of these especially preferred odorless aldehydes of formula (IV), which generate no perceptible odor in the polyurethane compositions, are esterification products derived from the above-indicated β-hydroxyaldehydes such as 3-hydroxypivalaldehyde, 3-hydroxyisobutyraldehyde, 3-hydroxypropanal, 3-hydroxybutyraldehyde, 3-hydroxyvaleraldehyde, 2-hydroxymethyl-2-methylbutyraldehyde, 2-hydroxymethyl-2-ethylbutyraldehyde, 2-hydroxymethyl-2-methylvaleraldehyde, 2-hydroxymethyl-2-ethylhexanal, 1-hydroxymethyl cyclopentanecarbaldehyde, 1-hydroxymethyl cyclohexanecarbaldehyde, 1-hydroxymethyl cyclohex-3-enecarbaldehyde, 2-hydroxymethyl-2-methyl-3-phenylpropionaldehyde, 3-hydroxy-2-methyl-2-phenylpropionaldehyde and 3-hydroxy-2,2-diphenylpropionaldehyde reacted with carboxylic acids such as, for example, lauric acid, tridecanoic acid, myristic acid, pentadecanoic acid, palmitic acid, margaric acid, stearic acid, nonadecanoic acid, arachidic acid, palmitoleic acid, oleic acid, erucic acid, linoleic acid, linolenic acid, elaeostearic acid, arachidonic acid, succinic acid, glutaric acid, adipic acid, pimelic acid, suberic acid, azelaic acid, sebacic acid, 1,12-dodecanedioic acid, maleic acid, fumaric acid, hexahydrophthalic acid, hexahydroisophthalic acid, hexahydroterephthalic acid, 3,6,9-trioxaundecanedioic acid and similar derivatives of polyethylene glycol, dehydrogenated ricinoleic acids, as well as fatty acids from industrial saponification of natural oils and fats such as, for example, rapeseed oil, sunflower seed oil, linseed oil, olive oil, coconut oil, palm kernel oil, and palm oil.

Preferred carboxylic acids are lauric acid, myristic acid, palmitic acid, stearic acid, oleic acid, linoleic acid, linolenic acid, succinic acid, adipic acid, azelaic acid, and sebacic acid and industrial mixtures of fatty acids containing these acids.

In a preferred method for synthesizing an aldehyde ALD of formula (IV), a β-hydroxyaldehyde, for example one of the above-indicated β-hydroxyaldehydes such as 3-hydroxypivalaldehyde, which for example can be synthesized from formaldehyde (or paraformaldehyde) and isobutyraldehyde, optionally in situ, is reacted with a carboxylic acid, in particular a long-chain fatty acid, to form the corresponding ester, namely either with a carboxylic acid Y⁶—COOH to form the corresponding carboxylic acid ester of, for example, 3-hydroxypivalaldehyde; and/or with a dicarboxylic acid monoalkyl ester HOOC—R⁴—COOR⁵ to form the aldehyde of formula (IV) with the residue Y⁶ as in formula (VI); and/or with a dicarboxylic acid HOOC—R⁴—COOH to form the aldehyde of formula (IV), in this case a dialdehyde, with the residue Y⁶ as in formula (V). The formulas (V) and (VI) and Y⁶, R⁴ and R⁵ in this case have the meaning described above. This esterification can be carried out without using a solvent according to known methods described, for example, in Houben-Weyl, Methoden der organischen Chemie [Methods of Organic Chemistry], Vol. VIII, pages 516-528.

When dicarboxylic acids are used, a mixture is obtained of aldehydes of formula (IV) with the residues Y⁶ as in formula (V) and as in formula (VI), if for example first some of the carboxylic acid groups are esterified with a β-hydroxyaldehyde, for example 3-hydroxypivalaldehyde, and then the rest of the carboxylic groups are esterified with an alkyl alcohol (R⁵—OH). Such a mixture can be further used directly to synthesize polyaldimine B1.

Suitable carboxylic acids for esterification with a β-hydroxyaldehyde, for example with 3-hydroxypivalaldehyde, are for example the above-indicated short-chain and long-chain carboxylic acids.

In a further embodiment, aldehydes ALD of the following formula (II) are used:

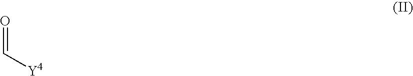

Y⁴ on the one hand can stand for a substituted or unsubstituted aryl or heteroaryl group, having a ring size between 5 and 8 atoms, preferably 6 atoms.

On the other hand, Y⁴ can stand for a residue of formula 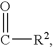
where R² in turn represents an alkyl, hydroxyl, or alkoxy group.

Finally, Y⁴ can stand for a substituted or unsubstituted alkenyl or arylalkenyl group with at least 6 C atoms.

Examples of aldehydes as in formula (II) are benzaldehyde, 2- and 3- and 4-tolualdehyde, 4-ethyl- and 4-propyl- and 4-isopropyl- and 4-butylbenzaldehyde, salicylaldehyde, 2,4-dimethylbenzaldehyde, 2,4,5-trimethylbenzaldehyde, 4-acetoxybenzaldehyde, 4-anisaldehyde, 4-ethoxybenzaldehyde, the isomeric di- and trialkoxybenzaldehydes, vanillin, o-vanillin, 2-, 3- and 4-carboxybenzaldehyde, 4-dimethylaminobenzaldehyde, 2-, 3- and 4-nitrobenzaldehyde, 2- and 3- and 4-formylpyridine, 2-furfuraldehyde, 2-thiophenecarbaldehyde, 1- and 2-naphthylaldehyde, 3- and 4-phenyloxybenzaldehyde; quinoline-2-carbaldehyde and its 3-, 4-, 5-, 6-, 7- and 8-positional isomers, anthracene-9-carbaldehyde, phthalaldehyde, isophthalaldehyde, terephthalaldehyde, as well as glyoxylic acid, glyoxylic acid methyl ester, and cinnamaldehyde.

Benzaldehyde, 4-dimethylaminobenzaldehyde, 3- and 4-phenyloxybenzaldehyde, phthalaldehyde, isophthalaldehyde, terephthalaldehyde, glyoxylic acid, and cinnamaldehyde are preferred.

By reaction of at least one polyamine PA, with aliphatic primary amino groups, with at least one aldehyde ALD of formula (I) or formula (II), for example polyaldimines B1 of structural formulas (VIl), (VIII), and (IX) are formed:

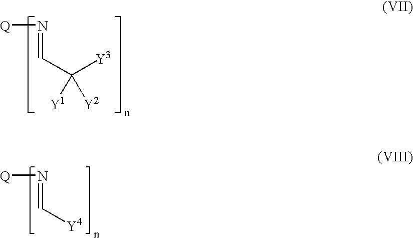

where n stands for 2, 3, or 4 and Q represents the residue of a polyamine with aliphatic primary amino groups after removal of all primary amino groups; and

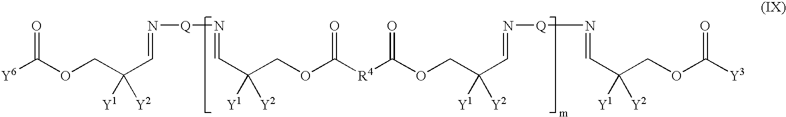

where m stands for an integer from 0 to 10 and Q is the same or different in the same molecule and in each case represents the residue of a polyamine with aliphatic primary amino groups after removal of all primary amino groups. The residues Y¹, Y², Y³, Y⁴, Y⁶, and R⁴ in formulas (VII), (VIII) and (IX) in this case have the meaning described above.

If a dialdehyde of formula (IV) with residue Y⁶ as in formula (V) is used to synthesize a polyaldimine B1, then it is advantageously used in a mixture with a monoaldehyde of formula (IV), more precisely in such a ratio of amounts that an average value of m is obtained in the range from 1 to 10 for the polyaldimine B1 as in formula (IX); or the dialdehyde as in formula (IV) is measured out so that there is an excess of aldehyde groups relative to amino groups in synthesis of the polyaldimine B1, where the excess amount of aldehyde is selected so that the average m is also obtained in the range from 1 to 10 for the polyaldimine B1 of formula (IX). For both approaches, a mixture of oligomeric polyaldimines is obtained with easily manageable viscosity.

Mixtures of various polyaldimines can also be used as polyaldimine B1, in particular also mixtures of various polyaldimines synthesized using various polyamines PA with aliphatic primary amino groups, reacted with different or the same aldehydes ALD of formula (I) or (II). It can also be quite advantageous to make mixtures of polyaldimines B1 by using mixtures of polyamines PA with different numbers of aliphatic primary amino groups.

For synthesis of the polyaldimine B1, the aldehyde groups of the aldehyde ALD are used in stoichiometric proportion or in stoichiometric excess relative to the primary amino groups of polyamine PA.

Usually the polyaldimine B1 of the second component B is used in a substoichiometric amount relative to the isocyanate groups of the prepolymer A1 of the first component A, and more precisely in an amount of 0.1 to 0.99 equivalents of aldimine groups per equivalent of isocyanate groups, in particular in an amount of 0.4 to 0.8 equivalents of aldimine groups per equivalent of isocyanate groups.

Furthermore, water is present in the second component B. The amount of water required for complete curing of the polyurethane composition can be calculated using formula (X):
(moles water=(eq aldimine)+[(eq NCO)−(eq aldimine)]/2 (X)

where “eq” stands for “equivalent”, “aldimine” stands for “aldimine groups”, and “NCO” stands for “isocyanate groups”.

The second component B does not have to contain the exact amount of water required for complete curing of the first component A, as calculated by formula (X). For example, it can contain a greater amount of water, such as twice the amount or more than twice the amount, or less water can be present in the second component B than calculated by formula (X). In this case, the rest of the water required for curing must be absorbed from moisture in the air. It is advantageous if at least the amount of water required to completely convert the polyaldimine to polyamine is present in the second component B. That is, the second component B preferably contains at least as many moles of water as equivalents of aldimine groups are present, or in other words: The second component B preferably has at least one molecule of water per aldimine group.

The water in the second component B either can be present as free water or it can be bound to a carrier. But the binding must be reversible, i.e., after the two components A and B are mixed, the water must be available for the reaction with the aldimine groups and the isocyanate groups.

Suitable carriers for component B can be hydrates or aqua complexes, in particular inorganic compounds with coordination of water or that have bound water as water of crystallization. Examples of such hydrates are Na₂SO₄·10H₂O, CaSO₄·2H₂O, CaSO₄·(½)H₂O, Na₂B₄O₇·10H₂O, MgSO₄·7H₂O.

Other suitable carriers are porous materials that trap water in voids. These include in particular special silicates and zeolites. Kieselguhr (diatomaceous earth) and molecular sieves are especially suitable. In this case the size of the voids is selected so that they are optimal for uptake of water. So molecular sieves with pore size of 4 Å have proven to be especially suitable.

Other suitable carriers are such that water is taken up in nonstoichiometric amounts and they have a pasty consistency or form gels. These carriers can be inorganic or organic. Examples include silica gels, clays such as montmorillonite, bentonites, hectorite, or polysaccharides such as celluloses and starches, or polyacrylic acids and polyacrylonitriles, which also are known as “superabsorbers” and are used, for example, in hygiene products. In addition, carriers bearing ionic groups are suitable. Especially preferred carriers are polyurethane polymers with carboxyl groups or sulfonic acid groups as side chains or their salts, in particular their ammonium salts. These carriers can take up water and bind it until their water absorption capacity is exhausted.

The particularly preferred polyurethane polymers with carboxyl groups or sulfonic acid groups as side chains or their salts can be obtained, for example, from polyisocyanates and polyols containing carboxylic acid or sulfonic acid groups. The acid groups can then, for example in the fully reacted state, be neutralized with bases, in particular tertiary amines. The properties of the carrier are strongly dependent on the functional group-containing polyols and polyisocyanates used. Attention must be especially paid to the hydrophilicity or hydrophobicity of the selected isocyanates and polyols. It has been shown that short-chain polyols especially yield very suitable carriers.

The following aids and additives, well known in the polyurethane industry, inter alia can additionally be present in the polyurethane compositions described:

Plasticizers, for example esters of organic carboxylic acids or their anhydrides, phthalates such as, for example, dioctylphthalate or diisodecylphthalate, adipates such as, for example, dioctyladipate, sebacates, organic phosphoric and sulfonic acid esters, polybutenes and other compounds that do not react with isocyanates; reactive diluents and crosslinkers, for example polyhydric alcohols, polyamines, polyaldimines, polyketimines or aliphatic isocyanates such as, for example, 1,6-hexamethylene diisocyanate, 2,2,4- and 2,4,4-trimethyl-1,6-hexamethylene diisocyanate, 1,12-dodecamethylene diisocyanate, cyclohexane-1,3-and -1,4-diisocyanate and any mixture of these isomers, 1-isocyanato-3,3,5-trimethyl-5-isocyanatomethylcyclohexane (=isophorone diisocyanate or IPDI), perhydro-2,4′- and -4,4′-diphenylmethane diisocyanate, 1,3- and 1,4-tetramethylxylylene diisocyanate, isocyanurates of these isocyanates, oligomers and polymers of these isocyanates as well as their adducts with polyols; inorganic and organic fillers, such as for example ground or precipitated calcium carbonates, which optionally are coated with stearates, in particular finely divided coated calcium carbonate, carbon black, kaolins, aluminum oxides, silicic acids and PVC powder or hollow spheres; fibers, for example made from polyethylene; pigments; catalysts such as, for example, organotin compounds such as dibutyltin dilaurate, dibutyltin dichloride, dibutyltin diacetylacetonate, organobismuth compounds or bismuth complexes, or amino group-containing compounds such as, for example, 2,2′-dimorpholinodiethyl ether, or other catalysts conventionally used in polyurethane chemistry for reaction of isocyanate groups; other catalysts for hydrolysis of polyaldimine such as, for example, organic carboxylic acids such as benzoic acid or salicylic acid, an organic carboxylic acid anhydride such as phthalic anhydride or hexahydrophthalic anhydride, a silyl ester of an organic carboxylic acid, an organic sulfonic acid such as p-toluenesulfonic acid or 4-dodecylbenzenesulfonic acid, or another organic or inorganic acid, or mixtures of the aforementioned acids; rheology modifiers such as, for example, thickeners, for example urea compounds, polyamide waxes, bentonites or pyrogenic silicic acids; adhesion promoters, in particular silanes such as epoxysilanes, vinylsilanes, isocyanatosilanes, and aminosilanes converted to aldiminosilanes by reaction with aldehydes, as well as oligomeric forms of these silanes; drying agents such as, for example, p-tosyl isocyanate and other reactive isocyanates, orthoformic acid esters, calcium oxide or molecular sieves; heat, light, and UV radiation stabilizers; flame retardants; surfactants such as, for example, wetting agents, flow-control agents, degassers or defoamers; fungicides or mold growth inhibitors; as well as other substances conventionally used in the polyurethane industry, where it is clear to the person skilled in the art whether or not these additional substances are suitable as additives for both or for only one of the two components A and B.

The two-component polyurethane composition according to the invention in particular also permits formulation of white compositions that cure rapidly without bubble formation. It is known that white water-curing systems often exhibit considerable bubble formation, since these systems do not contain any carbon black, which in black systems can partially suppress bubble formation.

Moisture is excluded during manufacture and storage of the two components, in particular the first component A. The two components are separately stable in storage, i.e., they can be stored in suitable packaging or devices, such as for example in a drum, a bag, or a cartridge, before use for several months up to a year or longer, without loss of usability. In one embodiment, the second component B can be stored in a container, as described further below, that is integrated into a dispensing attachment.

The two components can also be placed and stored in a container where they are separated by a partition. Examples of such containers include coaxial cartridges or twin cartridges.

It can be advantageous to adjust the consistency of the two components A and B to match each other, since pastes with similar consistencies can be more easily mixed.

The present invention makes it possible to formulate two-component polyurethane compositions that are completely free of organic solvents (volatile organic compoundsNOC). This is especially advantageous for environmental and occupational hygiene reasons.

The two components A and B are advantageously mixed continuously during application. In one possible embodiment, the two components A and B are mixed by means of a dispensing attachment containing two interlocking dispensing rotors. Such preferred dispensing attachments are described in detail in the patent EP 0 749 530. For smaller applications, the dispensing attachment is preferably mounted on a standard cartridge which contains the first component A, while the second component B is in a container integrated into the dispensing attachment. Dispensing and mixing are carried out during application in this dispensing attachment, which is driven passively by means of pressurization of the cartridge, for example by means of a standard cartridge squeezing device. For better mixing, in addition a static mixer can be mounted at the outlet of this dispensing attachment.

Another option for mixing the two components A and B is standard “twin cartridges” or “coaxial cartridges”, in each case with a static mixer mounted at the outlet. When twin cartridges are used, the two components A and B are in separate cartridges, mounted next to each other, which discharge into a common outlet. Application is carried out by means of a suitable squeezing device which squeezes both cartridges at the same time. When coaxial cartridges are used, both components are in the core of the cartridge. One component surrounds the other, where the components are separated by a coaxial wall. The two components are likewise squeezed out at the same time during application by means of a suitable squeezing device, and discharge into a common outlet.

However, for industrial applications, the two components A and B are advantageously delivered from drums or hobbocks. Here the two components A and B are advantageously mixed with a dispensing attachment, which is essentially distinguished from the above-described dispensing attachment by the fact that it has a hose connection for the second component B.

The two components A and B of the polyurethane composition can be blended by essentially uniform mixing or by essentially laminar mixing. Essentially uniform mixing is preferred. If the two components A and B are blended by essentially laminar mixing, for example by working with a static mixer with a small number of mixing elements, after complete curing a uniformly thoroughly cured product is nevertheless formed in which the original layers can no longer be seen. This fact is surprising to the person skilled in the art; it would be expected that for laminar mixing of polyaldimines into an isocyanate-containing polyurethane composition, at the layer boundaries zones would form which would not cure properly and therefore would remain soft, because there the ratio of polyaldimine groups to isocyanate groups is clearly in excess of stoichiometric. Usually isocyanate-containing polyurethane compositions actually do not cure properly if they are in contact with a stoichiometric excess of polyamine curing agent. The fact that even with essentially laminar mixing, components A and B are cured to form a uniform product is a great advantage in practice, since small nonuniformities can always appear even in an essentially uniform mixing process.

The mix ratio between the first component A and the second component B in principle can be freely selected, but a mix ratio A:B in the range 200:1 to 5:1 in parts by volume is preferred.

A typical application is carried out by first mixing the two components A and B of the polyurethane composition -as described, and then putting the mixed polyurethane composition in contact with at least one solid surface and curing. Typically the contact with the solid surface is made by application of a bead to the surface.

When the two components A and B are mixed, the hydrolyzed form of polyaldimine B1 reacts with the isocyanate groups, where formally a reaction occurs between the amino groups and the isocyanate groups; then the polyurethane composition at least partially cures. As already mentioned above, the equilibrium in the second component B, between the aldimine groups and the water on the one hand and the amino groups and the aldehyde on the other hand, is strongly shifted toward the aldimine groups and the water. However, if the second component B is brought into contact with the first component A, then formally the amino groups react with the isocyanate groups to form urea groups, and consequently the equilibrium steadily shifts toward the amino groups. As a result, the formal reaction between the polyaldimine B1 of the second component B and the isocyanate groups of the first component A completely runs its course. Excess isocyanate groups react either with the extra water present in the second component B or with water absorbed from the air (moisture in the air), which ultimately leads to complete curing of the polyurethane composition.

The reaction of the isocyanate group-containing polyurethane prepolymer A1 with the hydrolyzing polyaldimine B1 does not necessarily have to occur via the polyamine. Reactions with intermediate steps involving hydrolysis of the polyaldimine to form the polyamine are of course also possible. For example, it is conceivable that the hydrolyzing polyaldimine reacts, in the form of a hemiaminal, directly with the isocyanate group-containing polyurethane prepolymer A1.

As a consequence of the reactions described above, the polyurethane composition is cured.

The aldehydes used to make the polyaldimines B1 are liberated during curing. By using the special aldehydes ALD as in formula (I) or formula (II), in this case only a slight odor is perceptible. In an especially preferred embodiment, the aldehydes ALD used are distinguished by the fact that, due to their low vapor pressure, they remain in the cured polyurethane composition, and therefore they do not generate any perceptible odor. If long-chain fatty acids are used, the hydrophobic fatty acid residue results in poor absorption of water by the cured polyurethane composition, which increases the resistance of the polyurethane material to hydrolysis. Furthermore, when there is long-term contact with water, a hydrophobic fatty acid residue provides good protection against the aldehydes washing out of the cured polyurethane composition. These polyurethane compositions also have good photostability.

The described polyurethane compositions are distinguished by a long working time, high early strength, rapid and bubble-free curing, and by slight odor generation before, during, and after curing. They have extremely good adhesion to various solid surfaces, which because of their very rapid curing is certainly not self-evident, since experience indicates that rapidly curing polyurethane compositions tend toward weak development of adhesion. The cured two-component polyurethane composition has high elongation and high tensile strength. By varying, for example, the amount and type of polyaldimine B1 and the amount of water relative to the number of isocyanate groups, the working time can be varied and the development of early strength and the curing rate can also be affected.

Using the described polyurethane compositions, it is possible to formulate a modular two-component product system which consists of a universal first component A and a palette of various second components B. Depending on the requirements of an application, the most suitable component B can be combined with component A, which always remains the same. With such a system, polyurethane compositions with working times of different lengths, different early strengths and curing rates, odor generation of varying intensities during curing, and varying mechanical properties can be easily obtained without having to formulate component A again. This is a great advantage, for example for an adhesive manufacturer, since it is considerably more convenient if the moisture-sensitive first component A can be manufactured in large quantity in a formulation that stays the same.

The described polyurethane composition is suitable as an adhesive for bonding and sealing various substrates, for example for bonding components in manufacture of automobiles, track vehicles, ships, or other industrial goods, as any kind of sealant, for example for sealing joints in construction, as well as a coating or surfacing for various objects or various solid surfaces.

Preferred coatings include protective paints, seals, protective coatings, and primer coats. Floor coverings should be mentioned especially as preferred among surfacings. Such surfacings are typically made by pouring a reactive composition on the substrate and smoothing, where it cures to form a floor covering. For example, such floor coverings are used for offices, living areas, health care facilities, schools, warehouses, parking garages, and other personal or industrial applications. Since these applications involve extensive areas, even slight emission of substances from the covering can lead to occupational hygiene problems and/or annoying odors, even for outdoor application. However, most floor coverings are applied inside, which is why here we attach special importance to slight odor generation.

The polyurethane composition is at least partially in contact with the surface of any substrate. In the form of a sealant or adhesive, a coating or a surfacing, uniform contact is preferred, and more precisely in the areas which for the application require bonding in the form of a bond or seal or else for which the substrate must be covered. Physical and/or chemical pretreatment of the substrate or the articles that will be brought into contact may be quite necessary, for example by grinding, sand blasting, brushing, or the like, or by treatment with cleaning agents, solvents, adhesion promoters, adhesion promoter solutions or primers, or by applying a bond coat or a sealer.

### EXAMPLES

All percentages mean weight percent unless otherwise indicated.

Polyamines Used

alpha, omega-polyoxypropylenediamine (Jeffamine® D-230, Huntsman): Total primary amine content≧97%; amine content=8.22 mmol NH₂/g.

1,3-xylylenediamine (MXDA; Mitsubishi Gas Chemical): MXDA content≧99%; amine content=14.56 mmol NH₂/g.

Polvols Used

Acclaim® 4200 N (Bayer): Linear polypropylene oxide polyol with theoretical number of OH groups equal to 2, average molecular weight about 4000, OH value approx. 28 mg KOH/g, degree of unsaturation approx. 0.005 meq/g.

Caradol® MD34-02 (Shell): Nonlinear polypropylene oxide polyethylene oxide polyol, ethylene oxide-terminated, with theoretical number of OH groups equal to 3, average molecular weight approx. 4900, OH value approx. 35 mg KOH/g, degree of unsaturation approx. 0.08 meq/g.

### Description of Test Methods

The open time, i.e., the maximum possible time after application during which the adhesive can still be worked (for instance, by spreading or pressing down on solid surfaces or an article to be bonded), was determined on the basis of two criteria, namely consistency and adhesion, and more precisely as follows: The adhesive was applied as a triangular bead-approx. 1 cm wide on an LDPE film, and then the bead was covered at regular time intervals with a small glass plate that had been pretreated before use with Sika® Activator (obtainable from Sika Schweiz [Switzerland] AG) and air-dried for 10 minutes. Then the glass plate was immediately pressed to an adhesive thickness of 5, mm using a tensile tester (Zwick) and labeled with the time elapsed between bead application and pressing of the plate. The pressing force required was recorded. As soon as the pressing force exceeded 3 N, the open time was considered as ended. Additionally, the adhesion of the adhesive bead was tested for the test pieces that had been pressed within the open time, by curing the test pieces for one day at 23° C. and 50% relative air humidity and then peeling the adhesive off the glass. The last glass plate that still appeared to have completely cohesive adhesion provided the open time. In each case, the shorter of the two determined open times is the value listed.

The early strength was determined as follows: For each test, two small glass plates of dimensions 40×100×6 mm were pretreated on the side to be bonded with Sika® Activator (obtainable from Sika Schweiz [Switzerland] AG). After an air-drying time of 10 minutes, the adhesive was applied to the glass plate as a triangular bead parallel to the long edge. After approx. one minute, the applied adhesive was pressed down using a second glass plate and a tensile tester (Zwick) to a 5 mm adhesive thickness (corresponding to a bond width of approx. 1 cm), then it was stored at 23° C. and 50% relative air humidity. 5×3 test specimens were prepared in this way, where after different time intervals, depending on the curing rate for the composition, in each case three of the bonded glass plates were pulled away from each other at a pull rate of 200 mm/min, and the maximum force required to do this was recorded in N/mm bead length and averaged over the three samples. For each composition, the early strength was thus determined after several cure times.

The time to achieve 1 MPa tensile strength is also a measure of the early strength. It was determined using the tensile test described above. For this purpose, a tensile strength vs. curing time diagram was plotted, from which the time to achieve a tensile strength of 100 N/cm (corresponding to 1 MPa strength for a bond width of 1 cm) was read off.

The tensile strength and the elongation at break were determined on films with a layer thickness of 2 mm, cured for 7 days at 23° C. and 50% relative air humidity, according to DIN EN 53504 (pull rate: 200 mm/min).

The Shore A hardness was determined according to DIN 53505.

Bubble formation was qualitatively assessed based on the number of bubbles that appeared during curing of the films used for the mechanical tests (tensile strength and elongation at break).

The odor of the compositions was assessed by smelling with the nose at a distance of 10 cm for the films used for the mechanical tests (tensile strength and elongation at break) one hour after they were applied, at 23° C. and 50% relative air humidity.

The viscosity was measured at 20° C. on a Haake cone-and-plate viscometer (PK100/VT-500).

a) Preparation of Polyaldimines

Polyaldimine PA1

40.5 g formaldehyde (37% in water, methanol-free), 36.0 g isobutyraldehyde, 100.0 g lauric acid, and 1.0 g 4-toluenesulfonic acid were weighed out in a round-bottomed flask with a reflux condenser and a water trap (Dean-Stark) and placed under a nitrogen atmosphere. The mixture was heated in an oil bath with vigorous stirring, and water began to separate. After four hours, the apparatus was evacuated under a water-jet vacuum. A total of about 35 mL distillate was collected in the trap. The reaction mixture was cooled down, and 48.6 g of Jeffamine® D-230 was added from a dropping funnel. Then the volatile components were completely distilled off under vacuum. The reaction product obtained in this way (liquid at room temperature) had an aldimine content (determined as amine content) of 2.17 mmol NH₂/g, a viscosity at 20° C. of 700 mPa·s, and no perceptible odor.

Polyaldimine PA2

40.5 g formaldehyde (37% in water, methanol-free), 36.0 g isobutyraldehyde, 100.0 g lauric acid, and 1.0 g 4-toluenesulfonic acid were reacted as described for polyaldimine PA1, with separation of 35 mL water, and the reaction mixture thus obtained was mixed with 26.0 g MXDA. After removal of the volatile components under vacuum, a reaction product (liquid at room temperature) was obtained that had an aldimine content (determined as amine content) of 2.33 mmol NH₂/g and no perceptible odor.

Polyaldimine PA3

50.0 g of finely ground 3-hydroxypivalaldehyde (in dimer form) was suspended in 100 mL water in a round-bottomed flask, placed under a nitrogen atmosphere, and heated to 60° C. in an oil bath. Over a 30 minute period, 59.6 g of Jeffamine® D-230 was added dropwise from a dropping funnel, and a clear, pale yellow solution was obtained. Then the volatile components were completely distilled off under vacuum. The pale yellow reaction product obtained in this way (liquid at room temperature) had an aldimine content (determined as amine content) of 4.86 mmol NH₂/g and had a faint amine odor.

Polyaldimine PA4

16.3 g of glucose monohydrate was dissolved in 50 mL water in a round-bottomed flask, mixed with 0.05 g of p-toluenesulfonic acid, and placed under a nitrogen atmosphere. 10.0 g of Jeffamine® D-230 was added dropwise from a dropping funnel, and a clear, pale yellow solution was obtained. Then the volatile components were completely distilled off under vacuum. The yellowish brown reaction product obtained in this way (semifluid at room temperature) had an aldimine content (determined as amine content) of 3.52 mmol NH₂/g and no perceptible odor.

Polyaldimine PA5

25.0 g of finely ground 4-dimethylaminobenzaldehyde was suspended in 100 mL ethanol in a round-bottomed flask and placed under a nitrogen atmosphere. 19.4 g of Jeffamine® D-230 was slowly added dropwise from a dropping funnel, and a clear yellow solution was obtained. Then the volatile components were completely distilled off under vacuum. The dark yellow reaction product obtained in this way (semifluid at room temperature) had an aldimine content (determined as amine content) of 3.84 mmol NH₂/g and had a faint aromatic odor.

Polyaldimine PA6

25.0 g of 3,4,5-trimethoxybenzaldehyde was reacted with 14.8 g of Jeffamine® D-230 as described for polyaldimine PA5. After removal of the volatile components under vacuum, a yellow reaction product (semifluid at room temperature) was obtained that had an aldimine content (determined as amine content) of 3.23 mmol NH₂/g and a faint aromatic odor.

Polyaldimine PA7 (Comparison)

50.0 g of Jeffamine® D-230 was put in a round-bottomed flask and placed under a nitrogen atmosphere. With good cooling and vigorous stirring, 32.6 g of isobutyraldehyde was added from a dropping funnel. Then the volatile components were completely distilled off under vacuum. The reaction product obtained in this way (liquid at room temperature) had an. aldimine content (determined as amine content) of 5.81 mmol NH₂/g and a strong aldehyde odor.

b) Preparation of the First Component A

### Example 1 (Component A)

3400 g of a polyurethane prepolymer A1 (the preparation of which is described below), 1402 g of diisodecylphthalate (DIDP), 14 g of p-tolylsulfonyl isocyanate (TI® additive, Bayer), 21 g of 3-glycidoxypropyltrimethoxysilane (Silquest® A-187, OSI Crompton), 1052 g of calcined kaolin, 1052 g of carbon black, and 7 g of di-n-butyltin dichloride (1.8% in DIDP) were worked into a lump-free homogeneous paste in a vacuum mixer with exclusion of moisture and stored away from moisture. The material had an isocyanate group content of 0.241 mmol NCO/g and a density of 1.23 g/cm³.

After complete curing of the first component A alone by means of moisture in the air at 23° C. and 50% relative air humidity, it had

Shore A hardness of 47,

tensile strength of 7.4 MPa, and

elongation at break of 310%.

The polyurethane prepolymer A1 was prepared as follows:

1290 g of the polyol Acclaim® 4200 N, 2580 g of the polyol Caradol® MD34-02, 630 g of 4,4′-methylene diphenyl diisocyanate (MDI; Desmodur® 44 MC L, Bayer), and 500 g DIDP were reacted at 80° C. by a known method to form an NCO-terminated polyurethane prepolymer. The reaction product had a titrimetrically determined free isocyanate group content of 2.07 wt. % and a viscosity at 20° C. of 56 Pa·s.

c) Preparation of the second component B

### Examples 2 to 17 (Component B)

The components listed in Tables 2a and 2b were mixed in a vacuum mixer with exclusion of moisture and worked into a lump-free homogeneous paste, which was stored away from moisture.

The density of the components B according to Examples 2 to 17 corresponded to that of component A according to Example 1, except for Examples 5 and 14.

In Tables 2a and 2b, DIDP stands for diisodecylphthalate, DOA stands for dioctyladipate, and kaolin stands for calcinated kaolin. “Tin Cat.” stands for a solution of 1.8% di-n-butyltin dichloride in DIDP.

Ketimine in Table 2b and in Table 7 means the polyketimine derived from 3,3,5-trimethyl-5-aminomethyl cyclohexylamine (IPDA) and methyl ethyl ketone. It was prepared as described in U.S. Pat. No. 4,108,842 as “Hardener 1”. It had a ketimine content (determined as amine content) of 3.37 mmol NH₂/g and had an intense, pungent solvent odor.

TABLE 2
Composition of the second component B in parts by weight

| | Example | | | | | | | |
|---|---|---|---|---|---|---|---|---|
| | 2 | 3 | 4 | 5 | 6 | 7 | 8 | 9 |
| PA1 | 44.5 | 55.6 | 66.7 | 95.1 | 66.7 | 66.7 | — | — |
| PA2 | — | — | — | — | — | — | 62.1 | — |
| PA3 | — | — | — | — | — | — | — | 29.8 |
| Salicylic | 0.3 | 0.3 | 0.3 | 0.4 | 0.3 | 0.3 | 0.3 | — |
| acid | | | | | | | | |
| Water | 3.0 | 3.3 | 3.5 | 4.5 | 2.6 | 4.3 | 3.5 | 3.5 |
| DIDP | 22.0 | 10.6 | — | — | 0.2 | — | 3.9 | 36.5 |
| Pyrogenic | 2.0 | 2.0 | 2.0 | — | 2.0 | 2.0 | 2.0 | 2.0 |
| silicic acid | | | | | | | | |
| Kaolin | 28.2 | 28.2 | 27.5 | — | 28.2 | 26.7 | 28.2 | 28.2 |

| | Example | | | | | | | |
|---|---|---|---|---|---|---|---|---|
| | | | | | 14 | 15 | 16 | 17 |
| | 10 | 11 | 12 | 13 | Ref.* | Ref.* | Ref.* | Ref.* |
| PA1 | — | — | — | 76.6 | — | — | — | — |
| PA4 | 41.1 | — | — | — | — | — | — | — |
| PA5 | — | 37.7 | — | — | — | — | — | — |
| PA6 | — | — | 44.8 | — | — | — | — | — |
| PA7 | — | — | — | — | 27.9 | — | — | — |
| Ketimine | — | — | — | — | — | 42.9 | — | — |
| Dipropylene | — | — | — | 7.4 | — | — | — | 9.7 |
| glycol | | | | | | | | |
| Salicylic | 0.3 | 1.0 | 1.0 | 0.3 | 0.2 | 0.2 | — | — |
| acid | | | | | | | | |
| Water | 3.5 | 3.5 | 3.5 | 3.0 | 3.5 | 3.5 | 4.3 | — |
| DIDP | — | 27.6 | 20.5 | — | 38.2 | 23.2 | 65.5 | 59.1 |
| DOA | 24.9 | — | — | — | — | — | — | — |
| Pyrogenic | 2.0 | 2.0 | 2.0 | 12.7 | 2.0 | 2.0 | 2.0 | 2.0 |
| silicic acid | | | | | | | | |
| Kaolin | 28.2 | 28.2 | 28:2 | — | 28.2 | 28.2 | 28.2 | 28.2 |
| Tin Cat. | — | — | — | — | — | — | — | 1.0 |

*Ref. = comparison

d) Preparation and Testing of Cured Compositions

To prepare cured compositions, the first component A according to Example 1 was mixed with each second component B in 10:1 volume ratio.

The two components A and B were mixed continuously during application, by applying both components from a two-component 1:10 Mixpak polyethylene coaxial cartridge with attached static mixer (Sulzer Quadro model with 24 mixing elements). For Example 19 (second component B according to Example 5), 36 mixing elements were used because the second component B according to Example 5 did not contain any fillers, and so it was difficult to mix it into the first component A.

TABLE 3
Examples 18 to 21

| Example | 18 | 19 | 20 | 21 |
|---|---|---|---|---|
| Component A | Ex. 1 | Ex. 1 | Ex. 1 | Ex. 1 |
| according to | | | | |
| Component B | Ex. 2 | Ex. 3 | Ex. 4 | Ex. 5 |
| according to | | | | |
| Polyaldimine in | PA1 | PA1 | PA1 | PA1 |
| component B | | | | |
| NH₂/NCO | 0.4 | 0.5 | 0.6 | 0.7 |
| H₂O/NCO | 0.70^{a)} | 0.75^{a)} | 0.80^{a)} | 0.85^{a)} |
| Open time (minutes) | 40 | 35 | 25 | 10 |
| Early strength after | 9 | 17 | 78 | 120 |
| 180 minutes (N/cm) | | | | |
| Time to 1 MPa tensile | 360 | 300 | 200 | 160 |
| strength (minutes) | | | | |
| Tensile strength | 6.5 | 6.7 | 6.4 | 6.8 |
| (MPa) | | | | |
| Elongation at break | 430 | 460 | 460 | 480 |
| (%) | | | | |
| Shore A | 46 | 44 | 44 | 45 |
| Bubble formation | none | none | none | none |
| Odor | none | none | none | none |

^{a)}the exact amount of water required for complete curing of composition A is present, as calculated by the formula (X) defined above.

Examples 18 to 21 have different amounts of polyaldimine PA1. The ratio NH₂/NCO (i.e., equivalents of aldimine groups of second component B per equivalent of isocyanate groups of first component A) varies from 0.4/1 to 0.7/1. The amount of water in these mixtures, expressed as H₂O/NCO (i.e., the moles of water per equivalent of isocyanate groups) in each case is measured out so that there is exactly enough water to completely hydrolyze the polyaldimine and to cure the rest of the isocyanate groups of the polyurethane prepolymer.

As the polyaldimine content increases, the early strength also increases considerably, while the time to achieve 1 MPa tensile strength is shortened accordingly. The open time also decreases. There are only small differences in the mechanical properties of the cured compositions (tensile strength and elongation at break), despite different polyaldimine contents.

TABLE 4
Examples 22 and 23 compared with Example 20

| Example | 22 | 20 | 23 |
|---|---|---|---|
| Component A according to | Ex. 1 | Ex. 1 | Ex. 1 |
| Component B according to | Ex. 6 | Ex. 4 | Ex. 7 |
| Polyaldimine in component B | PA1 | PA1 | PA1 |
| NH₂/NCO | 0.6 | 0.6 | 0.6 |
| H₂O/NCO | 0.6^{b)} | 0.8^{a)} | 1.0^{c)} |
| Open time (minutes) | 40 | 25 | 10 |
| Early strength after 180 minutes | 34 | 78 | 150 |
| (N/cm) | | | |
| Time to 1 MPa tensile strength | 450 | 200 | 140 |
| (minutes) | | | |
| Tensile strength (MPa) | 6.2 | 6.4 | 6.4 |
| Elongation at break (%) | 450 | 460 | 420 |
| Shore A | 44 | 44 | 45 |
| Bubble formation | none | none | none |
| Odor | none | none | none |

^{a)}the exact amount of water required for complete curing of composition A is present, as calculated by the formula (X) defined above.
^{b)}only the amount of water required to hydrolyze the polyaldimine is present, the rest of the NCO groups need moisture from the air for curing.
^{c)}there is more water present than required for complete curing of composition A.

Neither Bubbles nor a Perceptible Odor Appear during Curing for all Four Examples.

Examples 20, 22, and 23 have a constant polyaldimine PA1 content but different amounts of water. So obviously raising the water content results in acceleration, for the open time as well as the early strength and the time to achieve 1 MPa tensile strength. There are hardly any differences in the tensile strength and the elongation at break. Neither bubbles nor a perceptible odor appear during curing for all three examples.

TABLE 5
Example 24 compared with Example 20

| Example | 20 | 24 |
|---|---|---|
| Component A according to | Ex. 1 | Ex. 1 |
| Component B according to | Ex. 4 | Ex. 8 |
| Polyaldimine in component B | PA1 | PA2 |
| NH₂/NCO | 0.6 | 0.6 |
| H₂O/NCO | 0.8 | 0.8 |
| Open time (minutes) | 25 | 20 |
| Early strength after 120 minutes | 40 | 230 |
| (N/cm) | | |
| Early strength after 180 minutes | 78 | ND |
| (N/cm) | | |
| Time to 1 MPa tensile strength | 200 | 85 |
| (minutes) | | |
| Tensile strength (MPa) | 6.4 | 6.2 |
| Elongation at break (%) | 460 | 400 |
| Shore A | 44 | 52 |
| Bubble formation | none | none |
| Odor | none | none |

″ND″ stands for ″not determined″

Example 24 differs from Example 20 in the polyaldimine used, where in each case the same aldehyde was reacted with two different polyamines. The different amines in fact did not have a great effect on the mechanical properties of the end product, but more so on early strength development: For similar open times, the early strength developed considerably faster in Example 24 than in Example 20. Both examples exhibit neither bubbles during curing nor a perceptible odor.

TABLE 6
Examples 25 to 29 compared with Example 20

| | Example | | | | | |
|---|---|---|---|---|---|---|
| | 20 | 25 | 26 | 27 | 28 | 29 |
| Component A | Ex. 1 | Ex. 1 | Ex. 1 | Ex. 1 | Ex. 1 | Ex. 1 |
| according to | | | | | | |
| Component B | Ex. 4 | Ex. 9 | Ex. 10 | Ex. 11 | Ex. 12 | Ex. 13 |
| according to | | | | | | |
| Polyaldimine in | PA1 | PA3 | PA4 | PA5 | PA6 | PA1 |
| component B | | | | | | |
| NH₂/NCO | 0.6 | 0.6 | 0.6 | 0.6 | 0.6 | 0.6 |
| H₂O/NCO | 0.8 | 0.8 | 0.8 | 0.8 | 0.8 | 0.6 |
| Open time (minutes) | 25 | 5 | 50 | 10 | 15 | 20 |
| Early strength after | 40 | ND | 35 | ND | 170 | 45 |
| 120 minutes (N/cm) | | | | | | |
| Early strength after | 78 | ND | 140 | ND | ND | ND |
| 180 minutes (N/cm) | | | | | | |
| Time to 1 MPa | 200 | 20 | 170 | 20 | 80 | 180 |
| tensile strength | | | | | | |
| (minutes) | | | | | | |
| Tensile strength | 6.4 | 5.3 | 5.6 | 5.2 | 5.1 | 6.1 |
| (MPa) | | | | | | |
| Elongation at break | 460 | 490 | 280 | 450 | 450 | 480 |
| (%) | | | | | | |
| Shore A | 44 | 36 | 49 | 42 | 40 | 42 |
| Bubble formation | none | none | none | none | none | none |
| Odor | none | slight | none | slight | slight | none |

“ND” stands for “not determined”

Examples 25 to 28 differ from Example 20 in the polyaldimine used, where in each case the same polyamine was reacted with different aldehydes. The open times as well as the early strengths are quite different. Example 25 is a very fast system. Because of the OH groups on the aldehyde, the cured material is softer than for Example 20, since some of the isocyanate groups do not crosslink with the moisture in the air but rather react with those OH groups. Example 26 has a long open time of 50 minutes, but is clearly faster in development of early strength than Example 20. This is an attractive combination in practice. The cleaved aldehyde has several OH groups and can therefore react with some of the isocyanate groups, and so can contribute to curing. Example 29, in addition to PA1, also contains dipropylene glycol; the properties are similar to those in Example 20.

None of the examples form bubbles while curing. Examples 25, 27, and 28 have a slight odor, while the other examples do not have any perceptible odor.

Examples 20 to 29 are evidence that it is possible to achieve a modular system consisting of a component A and different components B which clearly differ with respect to working times, early strengths, curing rates, odor, as well as mechanical properties and thus can be adjusted to the requirements of different applications.

The comparison Examples 30 (cleaves isobutyraldehyde) and 31 (cleaves methyl ethyl ketone) both have very high reactivity, which leads to an undesirably short open time. In each case, the odor during curing is not acceptable for the indicated applications.

Comparison example 32, which cures only by means of the water in component B, in fact has acceptable reactivity and no perceptible odor, but many bubbles form during curing and this is not acceptable for the indicated applications.

Comparison Example 33, which cures by means of a polyol, in fact has acceptable reactivity, no odor, and also no bubbles, but the surface of the cured composition remains very sticky since, due to the similar reactivity of water from the moisture in the air and the dipropylene glycol with the isocyanate groups, some of the polymer chains on the surface do not cure properly (chain terminations).

TABLE 7
Comparison Examples 30 to 33

| | 30 | 31 | 32 | 33 |
|---|---|---|---|---|
| Example | Ref.* | Ref.* | Ref.* | Ref.* |
| Component A according to | Ex. 1 | Ex. 1 | Ex. 1 | Ex. 1 |
| Component B according to | Ex. 14 | Ex. 15 | Ex. 16 | Ex. 17 |
| Curing agent in | PA 7, | ketimine, | only | dipropylene |
| Component B | water | water | water | glycol |
| NH₂/NCO | 0.6/1 | 0.6/1 | — | — |
| OH/NCO | — | — | — | 0.6/1 |
| H₂O/NCO | 0.8/1 | 0.8/1 | 1/1 | — |
| Open time (minutes) | 0.5 | 1.5 | 15 | 25 |
| Early strength after 30 | strong | strong | ND | ND |
| minutes (N/cm) | | | | |
| Early strength after 120 | ND | ND | 90 | 42 |
| minutes (N/cm) | | | | |
| Time to 1 MPa tensile | 8 | 25 | 125 | 210 |
| strength (minutes) | | | | |
| Tensile strength (MPa) | 6.5 | 7.2 | 7.2 | 5.5* |
| Elongation at break (%) | 440 | 400 | 330 | 500* |
| Shore A | 44 | 47 | 46 | 35* |
| Bubble formation | none | none | very | none |
| | | | many | |
| Odor | very | very | none | none |
| | strong | strong | | |

″ND″ stands for ″not determined″, ″Ref.″ stands for ″comparison″
*The cured composition has a very sticky surface.

1. Two-component polyurethane composition consisting of a first component A comprising
at least one polyurethane prepolymer A1 with isocyanate end groups,
synthesized from at least one polyisocyanate and at least one polyol and a second component B comprising
water
as well as at least one polyaldimine B1, which can be obtained from at least one polyamine PA with aliphatic primary amino groups and at least one low-odor aldehyde ALD as in formula (I) or formula (II), 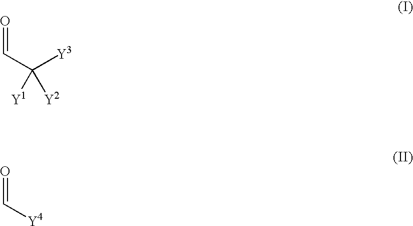
where Y¹ and Y²
either
each independently represent on the one hand a hydrogen atom, a hydroxyl group, or an organic residue;
or
together represent a carbocyclic or heterocyclic ring, having a ring size between 5 and 8 atoms, preferably 6 atoms;
and Y³
either
stands for a substituted or unsubstituted alkyl group having at least one hetero atom;
or
stands for a branched or unbranched alkyl or alkylene group with at least 10 C atoms;
or
stands for a substituted or unsubstituted aryl or arylalkyl group;
or
stands for 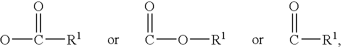
wherein R¹ stands for an aryl, arylalkyl, or alkyl group with at least 3 C atoms and in each case is substituted or unsubstituted;
and Y⁴
either
stands for a substituted or unsubstituted aryl or heteroaryl group, having a ring size between 5 and 8 atoms, preferably 6 atoms;
or
or stands for 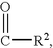
with R²=alkyl, hydroxyl, or alkoxy;
or
stands for a substituted or unsubstituted alkenyl or arylalkenyl group with at least 6 C atoms.

2. Two-component polyurethane composition as in claim 1, wherein the heteroatom in Y³ is present in the form of an ether oxygen or a carboxyl, ester, or hydroxyl group.

3. Two-component polyurethane composition as in claim 1, wherein the aldehyde ALD has formula (III), 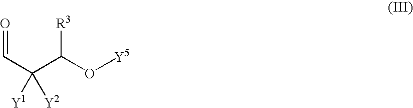
where R³ and Y⁵ each independently stand for a hydrogen atom or for an alkyl or arylalkyl group.

4. Two-component polyurethane composition as in claim 1, wherein the aldehyde ALD has formula (IV), 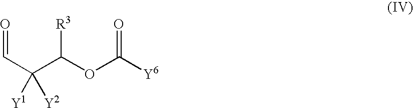
wherein
R³ stands for a hydrogen atom or for an alkyl or arylalkyl group, and Y⁶
either
represents a hydrogen atom;
or
represents an alkyl or arylalkyl or aryl group, which optionally has at least one hetero atom, optionally contains at least one carboxyl group, and optionally contains at least one ester group;
or
or represents a monounsaturated or polyunsaturated, linear or branched hydrocarbon chain.

5. Two-component polyurethane composition as in claim 4, wherein R³ stands for a hydrogen atom, and
Y⁶
either
stands for a linear or branched alkyl chain with 11 to 30 carbon atoms,
optionally with at least one hetero atom, in particular with at least one ether oxygen;
or
stands for a monounsaturated or polyunsaturated linear or branched hydrocarbon chain with 11 to 30 carbon atoms;
or
stands for a residue of formula (V) or (VI), 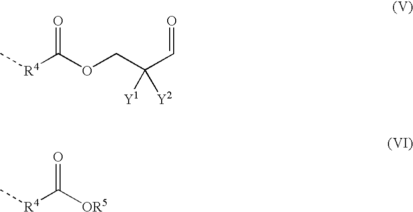
wherein
R⁴ either
stands for a linear or branched or cyclic alkylene chain with 2 to 16 carbon atoms, optionally with at least one hetero atom, in particular with at least one ether oxygen;
or
stands for a monounsaturated or polyunsaturated, linear or branched or cyclic hydrocarbon chain with 2 to 16 carbon atoms;
and
R⁵ stands for a linear or branched alkyl chain with 1 to 8 carbon atoms.

6. Two-component polyurethane composition as in claim 4, wherein the aldehyde ALD used to synthesize the polyaldimine can be obtained by means of an esterification reaction between a β-hydroxyaldehyde and a carboxylic acid, in particular without use of a solvent, where the β-hydroxyaldehyde is synthesized, optionally in situ, from formaldehyde or paraformaldehyde and a second aldehyde.

7. Two-component polyurethane composition as in claim 6, wherein the aldehyde ALD used to synthesize the polyaldimine can be obtained by means of an esterification reaction between 3-hydroxypivalaldehyde and a carboxylic acid, in particular without use of a solvent, where the 3-hydroxypivalaldehyde is synthesized, optionally in situ, from formaldehyde or paraformaldehyde and isobutyraldehyde.

8. Two-component polyurethane composition as in claim 6, wherein the carboxylic acid used to synthesize the aldehyde ALD is selected from the group including lauric acid, myristic acid, palmitic acid, stearic acid, oleic acid, linoleic acid, linolenic acid, succinic acid, adipic acid, azelaic acid, and sebacic acid, mixtures thereof, and their industrial mixtures with fatty acids.

9. Two-component polyurethane composition as in claim 1, wherein Y¹=Y²=methyl.

10. Two-component polyurethane composition as in claim 1, wherein the aldehyde ALD has formula (I) and Y¹ stands for a hydroxyl group, Y² stands for a hydrogen atom, and Y³ stands for an alkyl group with at least one hydroxyl group, in particular with more than one hydroxyl group.

11. Two-component polyurethane composition as in claim 1, wherein the polyamine PA with aliphatic primary amino groups is selected from the group consisting of 1,6-hexamethylenediamine, MPMD, DAMP, 2,2,4- and 2,4,4-trimethylhexamethylenediamine, 4-aminomethyl-1,8-octanediamine, IPDA, 1,3- and 1,4-xylylenediamine, 1,3- and 1,4-bis(aminomethyl)cyclohexane, bis(4-aminocyclohexyl)methane, bis(4-amino-3-methylcyclohexyl)methane, 3(4),8(9) -bis(aminomethyl)tricyclo[5.2.1.0^{2,6}]decane, 1,2-, 1,3- and 1,4-diaminocyclohexane, 1,4-diamino-2,2,6-trimethylcyclohexane, polyoxyalkylene polyamines with theoretically two or three amino groups, in particular Jeffamine® EDR-148, Jeffamine° D-230, Jeffamine® D-400 and Jeffamine® T-403, as well as mixtures of two or more of the aforementioned polyamines.

12. Two-component polyurethane composition as in claim 1, wherein for synthesis of the polyaldimine B1, the aldehyde ALD is used in stoichiometric proportion or in stoichiometric excess relative to the primary amino groups of the polyamine PA.

13. Two-component polyurethane composition as in claim 1, wherein the water in the second component B is present in free form or is reversibly bound to a carrier.

14. Two-component polyurethane composition as in claim 1, in that wherein the second component B has at least one water molecule per aldimine group.

15. Two-component polyurethane composition as in claim 1, wherein the polyol for synthesis of the polyurethane prepolymer A1 of the first component A has an average number of OH groups equal to 1.6 to 3.

16. Two-component polyurethane composition as in claim 15, wherein the polyol is a polyoxyalkylene polyol, in particular a polyoxyalkylene diol or triol, in particular a polyoxypropylene diol or triol or an EO-endcapped polyoxypropylene diol or triol.

17. Two-component polyurethane composition as in claim 15, wherein the polyol is a polyoxyalkylene polyol with a degree of unsaturation<0.02 meq/g and a molecular weight Mₙ from 1000 to 30 000 g/mol.

18. Two-component polyurethane composition as in claim 17, wherein the polyol is a polyol synthesized by means of DMC catalysis.

19. Two-component polyurethane composition as in claim 1, wherein the polyurethane prepolymer A1 in the first component A and the polyaldimine B1 in the second component B are present in a ratio from 0.1 to 0.99, in particular from 0.4 to 0.8 equivalents of aldimine groups per equivalent of isocyanate groups.

20. Method for mixing a two-component polyurethane composition as in claim 1, wherein the first component A and the second component B are blended by essentially uniform mixing.

21. Method for mixing a two-component polyurethane composition as in claim 1, wherein the first component A and the second component B are blended by essentially laminar mixing.

22. Method for mixing as in claim 20, wherein the mixing of the two components A and B is carried out by means of a dispensing attachment containing two interlocking dispensing rotors, as well as in addition optionally by means of a static mixer mounted at the outlet of this dispensing attachment.

23. Method for application of a two-component polyurethane composition as in claim 1, wherein it includes the following steps:
Mixing of the two components A and B
Making contact between at least one solid surface and the mixed polyurethane composition
Curing the mixed polyurethane composition.

24. Method for application as in claim 23, wherein the contact with the solid surface is made by applying a bead to the surface.

25. Use of a two-component polyurethane composition as in claim 1 as an adhesive, sealant, or surfacing, in particular as an adhesive or sealant.

26. Article which is tightly bonded with a mixed and cured two-component polyurethane composition as in claim 1.
